(19) United States
(12) Patent Application Publication
(10) Pub. No.: US 2013/0256212 A1
(43) Pub. Date: Oct. 3, 2013

(54) FILTRATION SYSTEM AND COMPONENTS THERE FOR

(71) Applicants: Ra'anan Ben-Horin, D.N. Jordan Valley (IL); Alexey Slavinsky, Kfar Hittim (IL)

(72) Inventors: Ra'anan Ben-Horin, D.N. Jordan Valley (IL); Alexey Slavinsky, Kfar Hittim (IL)

(73) Assignee: Amiad Water Systems Ltd., D.N. Upper Galil 1 (IL)

(21) Appl. No.: 13/993,564

(22) PCT Filed: Dec. 15, 2011
(86) PCT No.: PCT/IL11/50065

§ 371 Date: Jun. 12, 2013

Related U.S. Application Data
(60) Provisional application No. 61/423,787, filed on Dec. 16, 2010.

(51) Int. Cl. B01D 29/50; F16L 3/00; B01D 46/00

(52) U.S. Cl. CPC B01D 29/50; B01D 46/002; F16L 3/00
USPC 210/323.1; 55/482; 55/484; 137/561 A; 248/49

(57) ABSTRACT

A filtration array comprising a main raw fluid supply line and a main filtered fluid collecting line, at least one filtration flow path extending between the main raw fluid supply line and main filtered fluid collecting line, each at least one filtration flow path configured with a filtering assembly comprising a three or more filter units extending from a manifold configured on the filtration flow path and being in flow communication with the main raw fluid supply line and the main filtered fluid collecting line.

### FIELD OF THE DISCLOSED SUBJECT MATTER

The present disclosed subject matter is concerned with filtration systems. The disclosed subject matter is further concerned with a fluid distribution manifold for a filtration system, as well as with filtration assemblies.

The present disclosed subject matter is also concerned with a support structure for filtration systems.

### BACKGROUND OF THE DISCLOSED SUBJECT MATTER

A wide variety of fluid filtering systems is available, among which are also multiple filtering systems, i.e. systems comprising a plurality of integrated filtration units.

An important consideration in the field of filtering systems is the effective filtration volume (i.e. filtration capability of a filtration system) compared with the space such a filtration system occupies, and its footprint, i.e. the effective area occupied by a filtration system.

Yet an important consideration in the field of filtering systems is the ease at which servicing and maintenance may be attended to the system.

For that purpose there is a need for designing compact filtering systems as well as fluid couplings and supporting arrangements therefore.

### SUMMARY OF THE DISCLOSED SUBJECT MATTER

It is an object of the present disclosed subject matter to provide a filtration array configured with a plurality of filtration assemblies, each configured with a plurality of filter units.

According to a first aspect of the presently disclosed subject matter there is a filtration array comprising a main raw fluid supply line and a main filtered fluid collecting line, at least one filtration flow path extending between said main raw fluid supply line and main filtered fluid collecting line, each at least one filtration flow path configured with a filtering assembly comprising a plurality of filter units extending from a manifold configured on said filtration flow path and being in flow communication with the main raw fluid supply line and the main filtered fluid collecting line.

The filtration array comprises a main raw fluid supply line and a main filtered fluid collecting line, at least one filtering assembly extending between said main raw fluid supply line and said main filtered fluid collecting line; each of said at least one filtering assembly comprising three or more filter units; each of said filter units extending from a manifold being in flow communication with the main raw fluid supply line and the main filtered fluid collecting line.

An aspect of the disclosed subject matter is also concerned with a filtering assembly for mounting between a main raw fluid supply line and a main filtered fluid collecting line; said filtering assembly comprising three or more filter units, each of which units extending from a manifold configured for being in flow communication with the main raw fluid supply line and the main filtered fluid collecting line.

Any one or more of the following configurations, features and designs can be incorporated in a filtration array according to the disclosed subject matter, independently or in one or more combinations:
Each filtering assembly comprises three or more filter units;
A longitudinal axis of the manifold extends coaxial with the filtration flow path;
A longitudinal axis of the manifold extends in a plane defined by the main raw fluid supply line and the main filtered fluid collecting line and intersecting the longitudinal axis of the raw fluid supply line and of the main filtered fluid collecting line;
The main raw fluid supply line and the main filtered fluid collecting line extend parallel to one another;
The main raw fluid supply line and the main filtered fluid collecting line extend substantially horizontally;
The longitudinal axis of the manifold extends substantially vertically;
The filtration array comprises two or more filtering assemblies, said filtering assemblies disposed substantially parallel to one another;
The filter units of each filtering assembly extend substantially coplanar, with a longitudinal axis of each filter unit extending in a plane intersecting a plane defined by the main raw fluid supply line and said main filtered fluid collecting line;
The longitudinal axis of the filter units intersect the longitudinal axis of a respective filtration flow path;
The longitudinal axis of the filter units extend substantially horizontally;
The longitudinal axes of the filtration flow paths of the filtration array are substantially parallel to one another;
The longitudinal axes of the manifolds of the filtration array are substantially parallel to one another;
The filter units of one filtering assembly are disposed such that their longitudinal axis intersects a longitudinal axis of the filter units of a neighboring filtering assembly, however in different plains, i.e. as viewed along the filtration flow path;
The filter units of neighboring filtering assemblies are disposed at staggered planes such that longitudinal axes of filter units of one filtering assembly extend above/below the longitudinal axes of filter units of the neighboring filtering assembly;
The distance between two neighboring filtering assemblies is less than the axial length of a filter unit;
The filter units of a filtering assembly are symmetrically disposed (equiangular disposed) about the longitudinal axis of the respective manifold;
The filtration flow path is configured with at least one coupling to a drain line, extending between the main raw fluid supply line and the manifold of said filtration flow path;
The filtration flow path is configured with a faucet extending before and/or after the manifold of said filtration flow path.

According to another aspect of the presently disclosed subject matter there is provided a manifold for fluid coupling a plurality of filter units to a filtration flow path extending between a main raw fluid supply line and a main filtered fluid collecting line.

The manifold comprises a housing configured for coupling a plurality of filter units to a flow line extending between a main raw fluid supply line and a main filtered fluid collecting line, said manifold comprising a main inlet port configured for coupling to the main raw fluid supply line and extending to an inlet chamber, and a main outlet port configured for coupling to the main filtered fluid collecting line and extending to an outlet chamber; a plurality of filter unit couplers extending from the manifold housing, each configured for coupling thereto a filter unit; a distribution port associated with each filter unit coupler and extending from said inlet chamber and configured for coupling to an inlet port of a respective filter unit; and a collecting port associated with each filter unit coupler and extending form said outlet chamber and configured for coupling to an outlet port of a respective filter unit;

Any one or more of the following configurations, features and designs can be incorporated in a manifold according to the disclosed subject matter, independently or in one or more combinations:
The distribution port and collecting port of the filter unit couplers extend substantially coaxially;
The filter unit couplers are disposed symmetrically (equiangular) about a longitudinal axis of the manifold;
The manifold is configured for use in a filtration array comprising a main raw fluid supply line and a main filtered fluid collecting line, at least one filtering assembly extending between said main raw fluid supply line and said main filtered fluid collecting line; each of said at least one filtering assembly comprising three or more filter units; each of said filter units extending from the manifold being in flow communication with the main raw fluid supply line and the main filtered fluid collecting line;
A longitudinal axis of the filter unit couplers extends substantially normal to the longitudinal axis of the manifold;
The filter unit couplers are screw-type or bayonet-type couplers;
The manifold is made as a unitary injection molded article;
The main inlet port and the main outlet port are configured for direct or indirect coupling to the main raw fluid supply line and the main filtered fluid collecting line, respectively;
The filter unit couplers are disposed symmetrically about a longitudinal axis of the manifold;
A longitudinal axis of the filter unit couplers extends substantially normal to the longitudinal axis of the manifold.

According to yet another aspect of the presently disclosed subject matter there is provided a support system for retaining a filtration array.

The support system comprises a pair of ground supports each configured with at least a main line support portion for supporting one of a main raw fluid supply line and a main filtered fluid collecting line; a filtration assembly arresting portion for coupling to a filtration assembly extending between the main raw fluid supply line and the main filtered fluid collecting line, and a bracing arrangement for interconnecting two neighboring supports.

According to one particular example the support system comprises a pair of supports each configured with a ground engaging portion configured for resting over a ground surface; at least a main line support portion for supporting one of a main raw fluid supply line and a main filtered fluid collecting line; and a bracing arrangement for interconnecting two neighboring supports and arresting a portion of a filtration assembly extending substantially vertically between the main raw fluid supply line and the main filtered fluid collecting line.

Any one or more of the following configurations, features and designs can be incorporated in a support system according to the disclosed subject matter, independently or in one or more combinations:
The support is configured with a main line support portion for supporting a bottom one of the main raw fluid supply line and the main filtered fluid collecting line;
The ground supports are each composed of two symmetric members disposed in a mirror-like fashion and fastened to one another;
The ground supports and/or bracing arrangement are made of injection molded material. Optionally the ground supports and/or bracing arrangement are made of polymeric material;
The bracing arrangement is composed of two symmetric members disposed in a mirror-like fashion and fastened to one another;
The bracing arrangement serves also as the filtration assembly arresting portion, configured for bracing arresting either a pipe section extending from a bottom one of the main raw fluid supply line and the main filtered fluid collecting line to the manifold, or a lower extension pipe portion of the manifold
A longitudinal axis of the bracing arrangement extends substantially perpendicular to the at least main line support portion;
A longitudinal axis of the bracing arrangement extends substantially normal to the support portion of the ground support.

It is appreciated that the filter unit in the following examples can be any type of filtering media such as a stack of filtering disks, a filtering screen (i.e. a fine mesh of material) or a thread-type cylinder, etc,.

Also, the term fluid as used herein the specification and claims is defined as any flowable matter, i.e. gas or liquid, regardless its purpose, degree of contamination, particle size, viscosity, pressure or any other parameters. Hence, herein in the specification and claims the term fluid is used in its broadest sense.

Raw fluid denotes a fluid (gas or liquid) to be filtered, and Rinsing fluid denotes a fluid (gas or liquid) used for rinsing/flushing the filter unit or filtering media or other components of the filter assembly. It is noted that in some cases filtered fluid serves as a rinsing fluid. Filtered fluid denotes the fluid/liquid obtained after a filtration process, namely after removing particles and contaminating matter.

Respective inlet ports and outlet ports may serve for more than one function. For example, a certain port may function at one stage as a raw fluid inlet port and at another stage may function as a waste/rinsing outlet port. Also, fluid flow can take place in reverse direction, depending on the particular intended configuration.

### BRIEF DESCRIPTION OF THE DRAWINGS

In order to understand the different aspects of the disclosed subject matter, and to see how it may be carried out in practice, embodiments will now be described, by way of non-limiting examples only, with reference to the accompanying drawings, in which:

FIG. 1 is a perspective view of a filtration array in accordance with a first aspect of the present disclosed subject matter;

FIG. 2 is a side view of the filtration array of FIG. 1;

FIG. 3A is a side view of the filtration array of FIG. 1;

FIG. 3B is a section taken along line in FIG. 2;

FIG. 4 is a section taken along line IV-IV in FIG. 3A;

FIG. 5 is a top view of the filtration array of FIG. 1;

FIG. 6A is a side view of a modification of a filter array in accordance with the first aspect of the presently disclosed subject matter;

FIG. 6B is a side view of the filtration array of FIG. 6A;

FIG. 7A is a top perspective view of a manifold element in accordance with another aspect of the presently disclosed subject matter;

FIG. 7B is a section taken along line VII-VII in FIG. 7A;

FIGS. 7C and 7D are a perspective view of a multiple filter unit assembly;

FIG. 8 is a perspective view of a support system for retaining a filtration array, in accordance with yet another aspect of the present disclosed subject matter FIG. 9A is partial front view illustrating how the filtration array is articulated to the support system;

FIG. 9B is a side view of FIG. 9A; and

FIG. 9C is a partial front view illustrating a modification of FIG. 9A.

### DETAILED DESCRIPTION OF SPECIFIC EXAMPLES

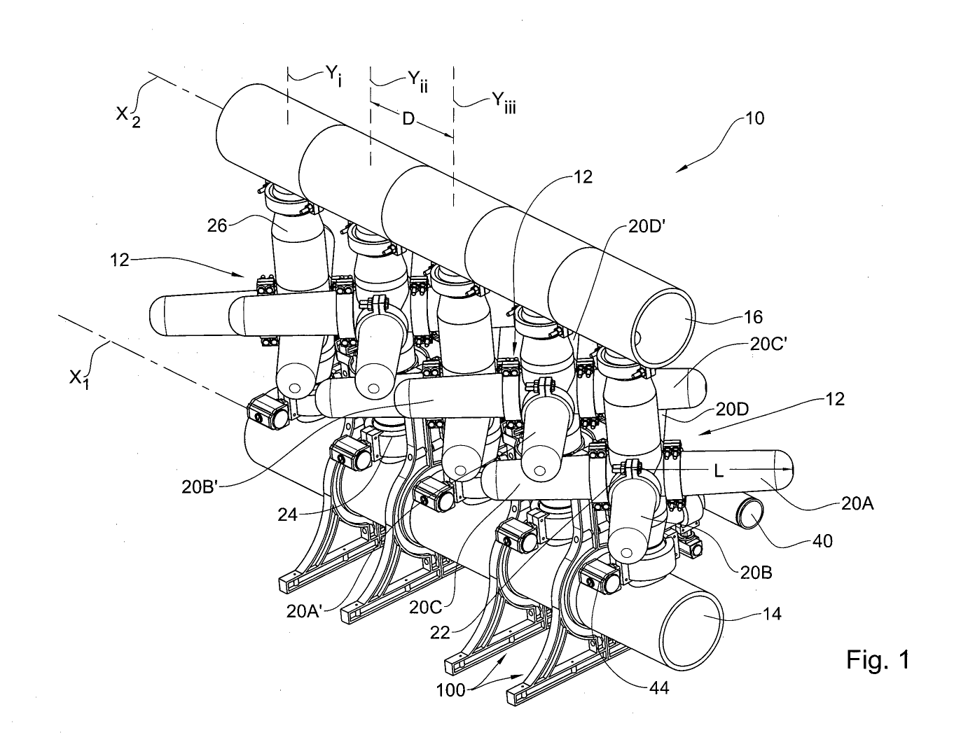

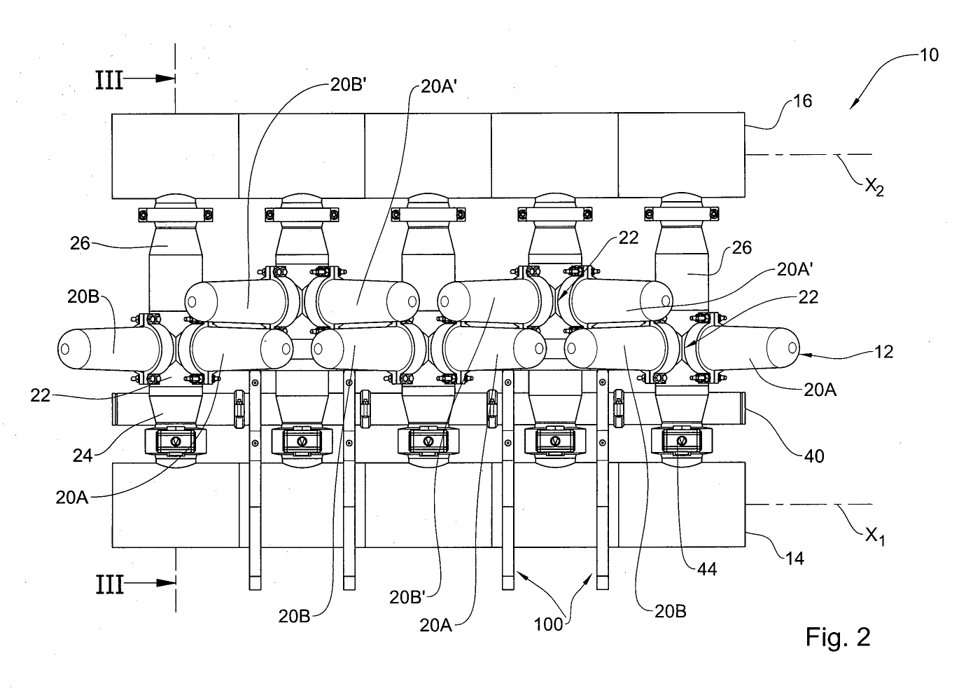

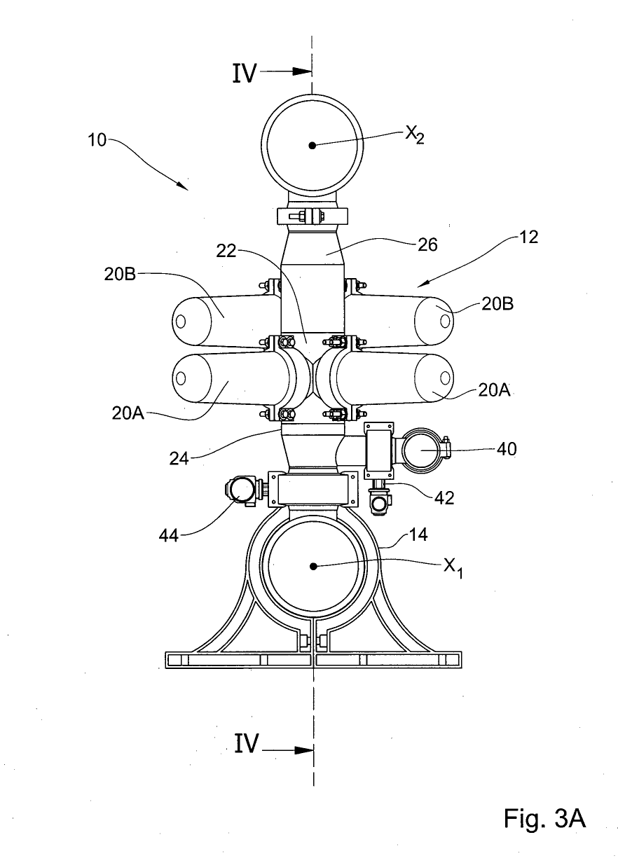

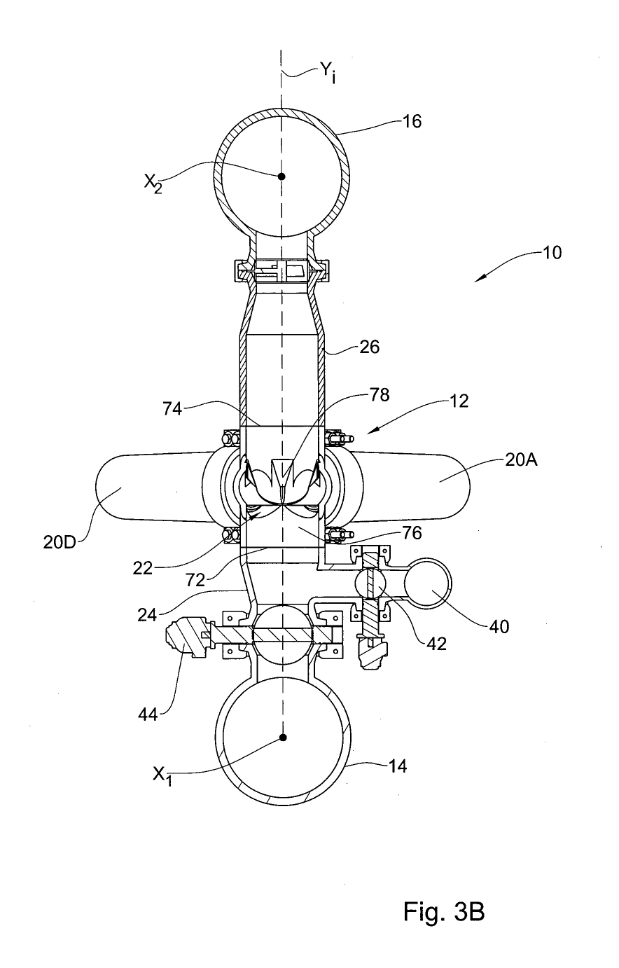

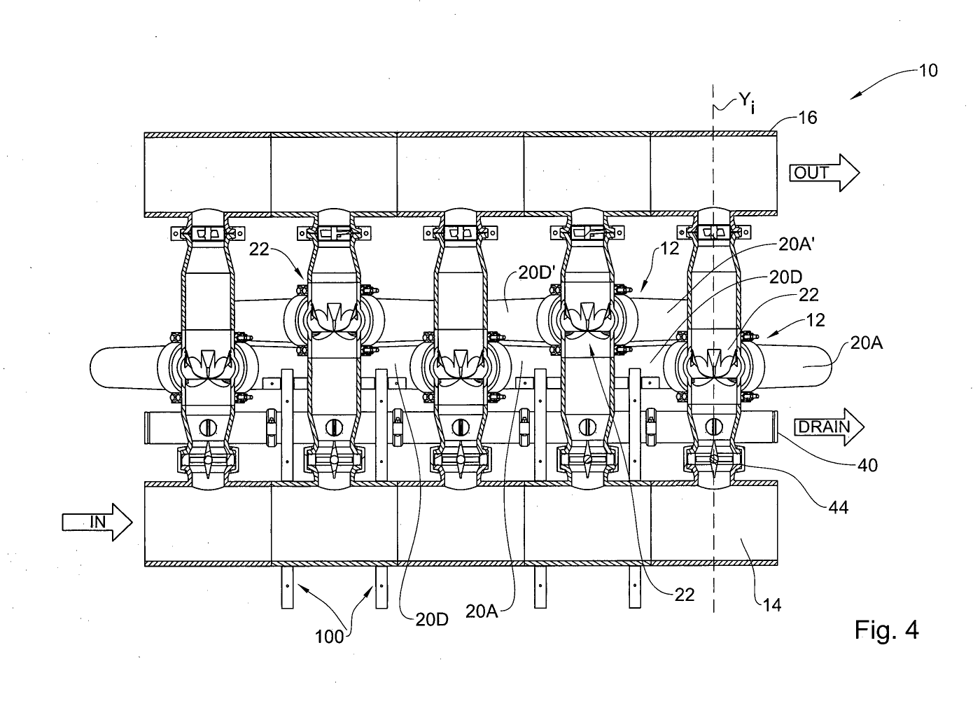

With attention first being drawn to FIGS. 1 to 6B, there is illustrated a filtration array generally designated 10, in accordance with a first aspect of the present disclosed subject matter.

The filtration array 10 comprises a plurality of filtering assemblies 12 (five shown in the present example) extending between a main raw fluid supply line 14 and a main filtered fluid collecting line 16.

In the present example the main raw fluid supply line 14 and the main filtered fluid collecting line 16 extend substantially horizontal and parallel to one another (namely longitudinal axis X₁ being substantially parallel to longitudinal axis X₂) and defining together a substantially vertically extending plain. Each of the filtering assemblies 12 is configured on a filtration flow path defined between the main raw fluid supply line 14 and a main filtered fluid collecting line 16, said filtration flow path extending substantially vertically and designated Yᵢ, i.e. with the plain and perpendicular to the longitudinal axes X₁ and X₂.

Each of the filtering assemblies 12 comprises a plurality of filter units 20 (four in the present example, though the filtration array can be configured with any practical number of filtering assemblies). The filter units 20 of a filtering assembly are designated 20A, 20B, 20C and 20D, and the filter units of a neighboring filtering assembly are designated 20A′, 20W, 20C′ and 20D′, respectively.

It is appreciated that the filter units in the following examples can be any type of filtering media such as a stack of filtering disks, a filtering screen (i.e. a fine mesh of material) or a thread-type cylinder, etc, or a combination of filtering units.

Further noted in FIGS. 1 to 5, a central drain line 40 extends along the filtration array 10 being in flow communication with the filtration flow path, namely extending below and coupled to each of the filtering assemblies 12 via a hydraulic faucet 42, for selective draining of the filtering assemblies. In addition, a second faucet 44 is provided for each of the filtering assemblies 12 for selective opening/closing fluid flow from the main raw fluid supply line 14 through the interconnecting inlet pipes 24.

A faucet between the manifold and the main filtered fluid collecting line 16 van be configured (not shown) for shutting flow through a elected filtering flow path, e.g. for servicing same however without interrupting with operation of other filtration systems in the array.

Whilst in the illustrated example the drain pipe 40 extends below the manifold 22, according to other examples (not shown) the drain pipe can be configured above the manifold, i.e. where the main raw fluid supply line extends above the filtered fluid collecting line.

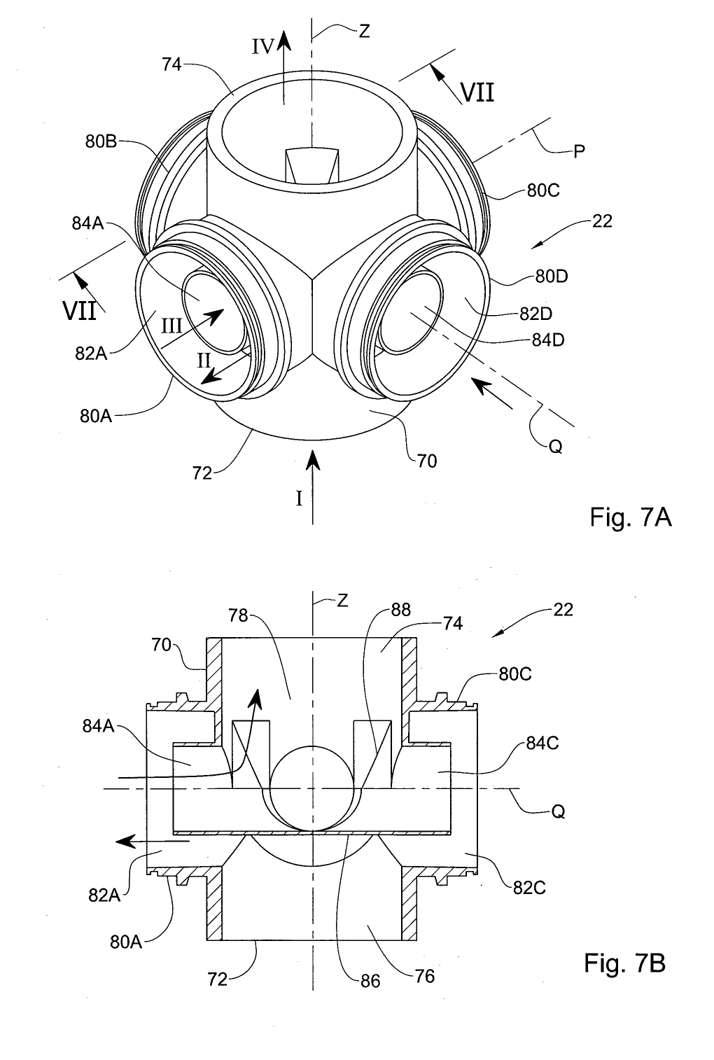

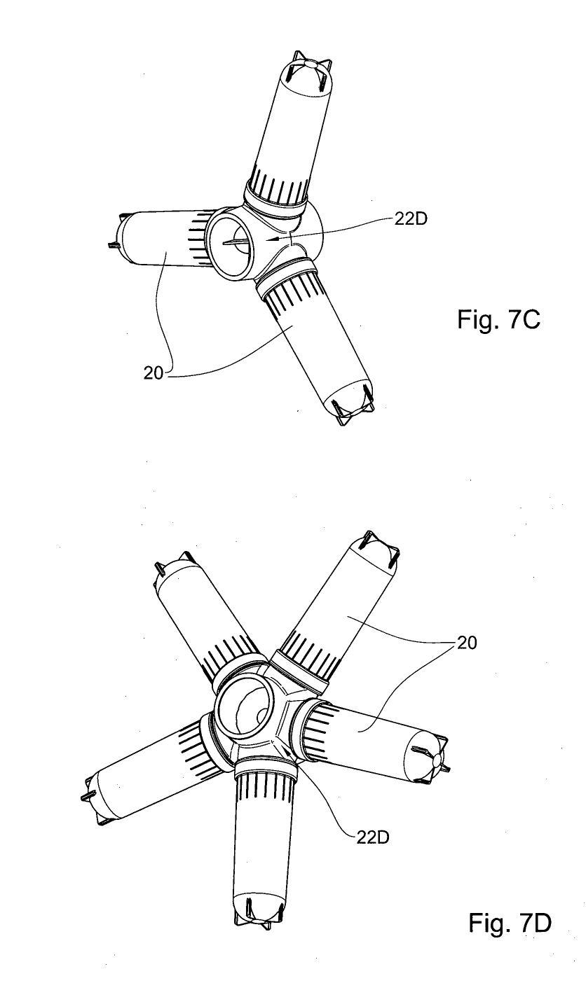

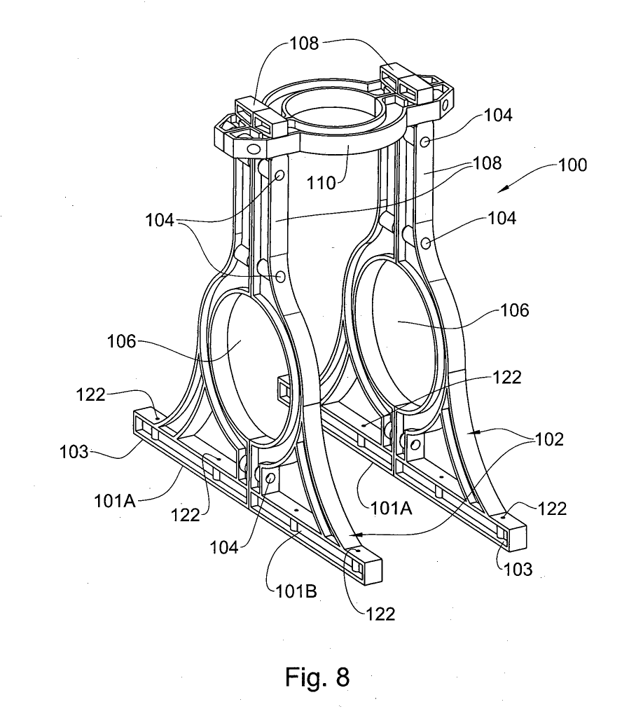

The filter units 20 of a filtering assembly 12 extend from a common manifold 22 referred to hereinafter in detail with reference to FIGS. 7A and 7B. The manifold 22 is coaxial with the filtration flow path and is configured with an inlet port 72 extending in flow communication with the main raw fluid supply line 14 via an interconnecting inlet pipe 24, and in flow communication with the main filtered fluid collecting line 16 via interconnecting outlet pipe 26.

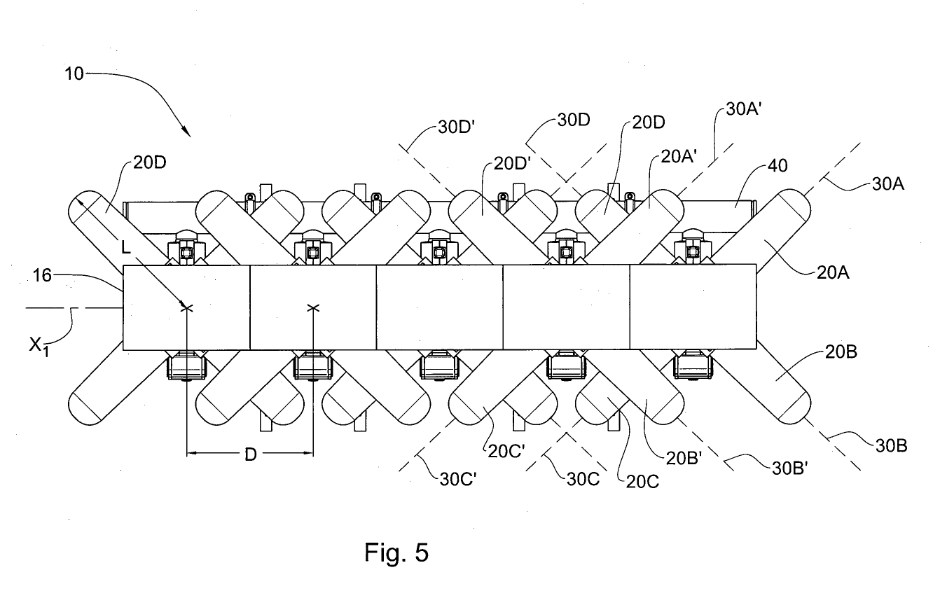

As can be seen in FIGS. 1 to 4, the arrangement between neighboring filtering assemblies 12 is such that the respective filter units 20A, 20B, 20C and 20D of one filtering assembly 12, and the filter units 20A′, 20B′, 20C′ and 20D′ of a neighboring filtering assembly 12 are vertically staggered, namely do not extend at the same level. Furthermore, as can best be seen in the top view of FIG. 5, it is noted that the longitudinal axis 30A of filter units 20A are substantially parallel to respective longitudinal axis 30A″ of filter units 20A′ and likewise the longitudinal axis 30B of filter units 20B are parallel to respective longitudinal axis 30B′ of filter units 20W, and the longitudinal axis 30C of filter units 20C are parallel to respective longitudinal axis 30C′ of filter units 20C″ and similarly the longitudinal axis 30D of filter units 20D are parallel to respective longitudinal axis 30D″ of filter units 200′.

The arrangement disclosed is such that the coaxial axis extending along axes 30A-30C is thus parallel to the coaxial axis extending along axes 30A′-30C′, the coaxial axis extending along axes 30B-30D is thus parallel to the coaxial axis extending along axes 30B′-30D′, and accordingly axis 30A-30C intersects (at a right angle in the particular example) the axis 30B-30D, and likewise axis 30A′-30C′ intersects (at a right angle in the particular example) the axis 30B′-30D′. Also, axis 30C intersects axis 30B′, axis 30D intersects axis 30A′, etc.

It is appreciated that a quadrant configuration of filtering assemblies is a particular example and other configurations can be performed as well, i.e. as far as the number of filter units 20 in each filtering assembly 12 (e.g. as illustrated in FIGS. 7C and 7D), vertical staggering of neighboring filtering assemblies (i.e. staggering can take place in different order rather than altering as in the given example), etc.

As can further be noted in FIG. 5, the length of the projection of the length L over longitudinal axis X₁ (the length L is measured from the center line of the filtering assembly 12 up to the end of the filter unit 20) is greater than half the distance D extending between two neighboring longitudinal axes of filtering assemblies 12, i.e. L>D/2.

This configuration provides for a space efficient layout of the filter units and their respective filtering assemblies of the filtration array, i.e. obtaining an small footprint yet allowing easy access to each filter unit, for ease maintenance and servicing thereof.

The space saving configuration disclosed hereinabove is facilitated owing to the configuration of the respective filtering assemblies and their respective filter units with respect to one another and this in turn is facilitated owing to the construction of the manifold 22 (discussed hereinafter with reference to FIGS. 7A and 7B).

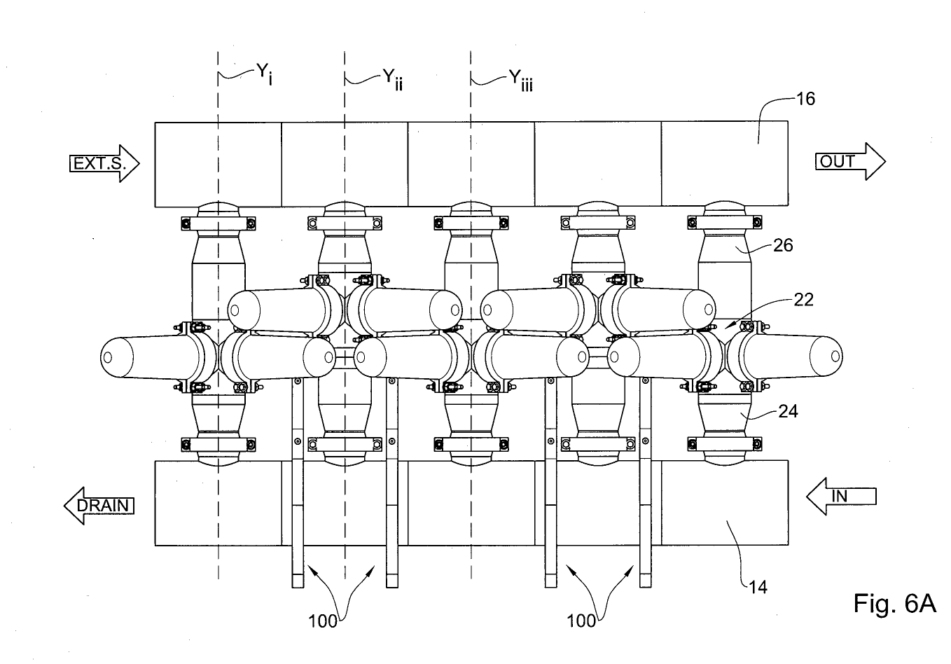

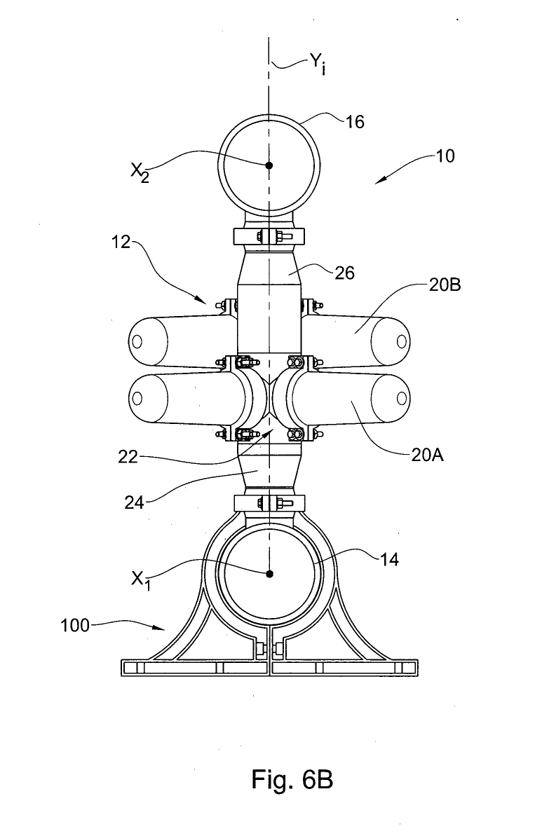

The configuration of FIGS. 6A and 6B is principally similar to that disclosed in former FIGS. 1 through 5 and accordingly like reference numbers are used. However, the configuration illustrated in FIGS. 6A and 6B is devoid of said central draining line 40 and hydraulic faucets 42 and 44.

It is further appreciated that whilst in the present illustrations of FIGS. 1 to 6 the main raw fluid supply line 14 and the main filtered fluid collecting lines 16 extend substantially parallel to one another and are disposed in a substantially horizontal orientation, in accordance with different configurations (not illustrated) these main pipe lines may extend in a non parallel relation or not above one another as illustrated. Even more so, whilst in the present illustrated examples the longitudinal axis Y of the filtering assemblies 12 (i.e. the filtration flow paths) extend vertically and parallel to one another (Yᵢ extending parallel to Yᵢᵢ, in turn extending parallel to Yᵢᵢᵢ; etc.) the longitudinal axes of each filtering assembly may extend in a non parallel relation and not necessarily at a vertical orientation. For that purpose there may be required appropriate coupling and adapting elements (not illustrated).

Turning now to FIGS. 7A and 7B, particular reference is made to the manifold 22 associated with each of the filtering assemblies 12 disclosed hereinbefore and however being suitable for use with any filtration assembly.

Note should be made that whilst in the present example the manifold 22 is configured for use with four filter units 20, the same principle design may be made, mutatis mutandis for use with any practical number of filter units, e.g. two, three, four or even five such filter units. For sake of illustration, FIGS. 7C and 7D illustrate a manifold 22C and 22D, holding three and five filter units 20, respectively, with the filtering units radially extending therefrom about a plain substantially normal to the longitudinal axis of the manifold 22, i.e. in a star-like configuration, same as in the previous example. Evenmoreso, a manifold 22 can be fitted with a sealing cap instead of a filter unit (e.g. a faulty one, or where environment provided poor or limited access).

The manifold 22 comprises a substantially cylindrical body 70 configured with a main inlet port 72 configured for coupling to the main raw fluid supply line via the interconnecting inlet pipe 24 (see FIGS. 1 through 6), and a main outlet port 74 configured for coupling to the main filtered fluid collecting line 16 via the interconnecting outlet pipe 26, thus giving rise to said filtration flow path.

As can best be seen in FIG. 7B, the main inlet port 72 extends into an inlet chamber 76 and the main outlet port 74 extends from an outlet chamber 78. A plurality of filter unit couplers (four in the present example; designated 80A, 80B, 80C and 80D, respectively) extend from the housing 70, each filter unit coupling 80A to 80D configured for coupling there to a respective filter unit (20A to 20D and 20A′ to 20D′ in FIGS. 1 to 6), e.g. by screw coupling, bayonet coupling, etc.

If required, an interconnecting coupler can be used. Each filter unit coupler is configured with a distribution port 82A, 82B, 82C and 82D, respectively, extending from the inlet chamber 76, and a collecting port 84A, 84B, 84C and 84D respectively, extending from the outlet chamber 78, wherein said distribution ports 82A to 82D extend coaxially over the collecting ports 84A to 84D. In a respective manner, the distribution ports 82A to 82D are in flow communication with a respective inlet of a filter unit and the collecting ports 84A to 84D are in flow communication with a respective outlet port of the filter units 20, whereby the filter units are functionally coupled to the respective raw fluid supply line 14 and the filtered fluid collecting line 16, forcing the fluid to flow through the filtering media. It should be noted that in fact, a filtration element is screw coupled, or otherwise articulated over the tubular projection of the collecting ports 84A to 84D, whilst the housing of each filter unit is screw coupled to the external threading at 80A to 80D.

As can best be seen in FIG. 7B, that the manifold 22 is configured with a configuration of partition walls 86 and 88 preventing direct fluid flow from the inlet chamber 76 to the outlet chamber 78, thus preventing raw fluid from contaminating filtered fluid.

It is also noted from the figures here insofar, that a longitudinal axis Z of the manifold 22 extends coaxial with the filtration flow path, i.e. the longitudinal axis Yᵢ of each of the filtering assemblies 12 and that the filter unit couplers 80A through 80D extend about perpendicular axes Q and P, intersecting one another and defining a plane substantially normal to the axis Z, said axes Q and P extending coaxial with the longitudinal axes 30B to 30D and 30A′ to 30D′ of the filter units 20A to 20D and 20A′ to 20D′, respectively.

Whilst in the particular example as illustrated herein the filtering assemblies 12 each comprise a plurality of filter units 20, extending coplanar and about a substantially horizontal plain (i.e. the axes Q and P intersect the longitudinal axis Z of the manifold at a right angle), there can be other configurations wherein the filter units are disposed about an angle other than 90°, e.g. with their respective free ends extending above their point of articulation to the manifold, thereby reducing evermore the footprint of the filtration assemblies.

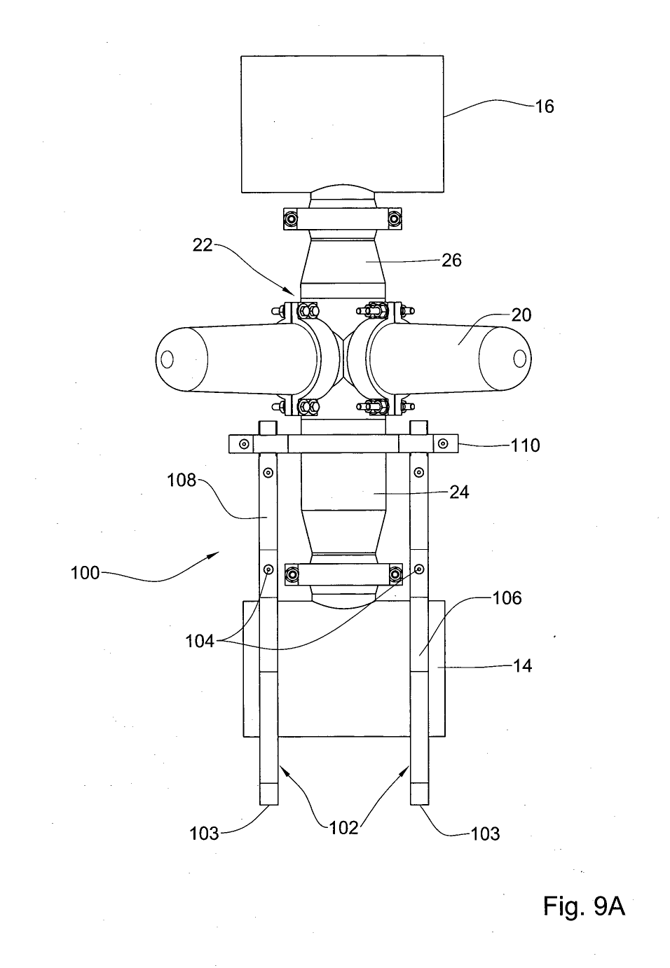

Further attention is now directed to FIG. 8 of the drawings illustrating a support system generally designated 100, in accordance with another aspect of the present disclosed subject matter. The support system 100, seen also in FIGS. 1 to 6, is configured for retaining a filtration array, for example of the previously disclosed subject matter, in a sturdy and fixed orientation and for that purpose, several support systems are disposed along the length of a filtration array.

The support system 100 comprises a pair of supports 102 each configured with a widened base ground engaging portion 103 configured for resting or supporting to a ground surface, and a main line support portion 106 which in the present example is configured as an annular portion designed for bracing a main raw fluid supply line 14 (not shown in FIG. 8) of the filtration array 10 seen in FIGS. 1 to 6. Upwardly extending from each support 102 there is an upward projection 108 where in the two supports 102 are interconnected by a bracing member 110 configured for interconnecting the two neighbouring supports 102 and arresting the interconnecting inlet pipe 24 (not shown in FIG. 8) of each filtering assembly 12 in the filtration array 10.

Ground anchoring locations 122 are configured at the ground engaging portion 103, through which securing studs or other securing members can be inserted into the ground for fixing the structure.

The supports 102 can be made, for example, of moulded plastic material, reinforced by plurality of ribs and/or with reinforcing material e.g. reinforcing fibrous material, etc.

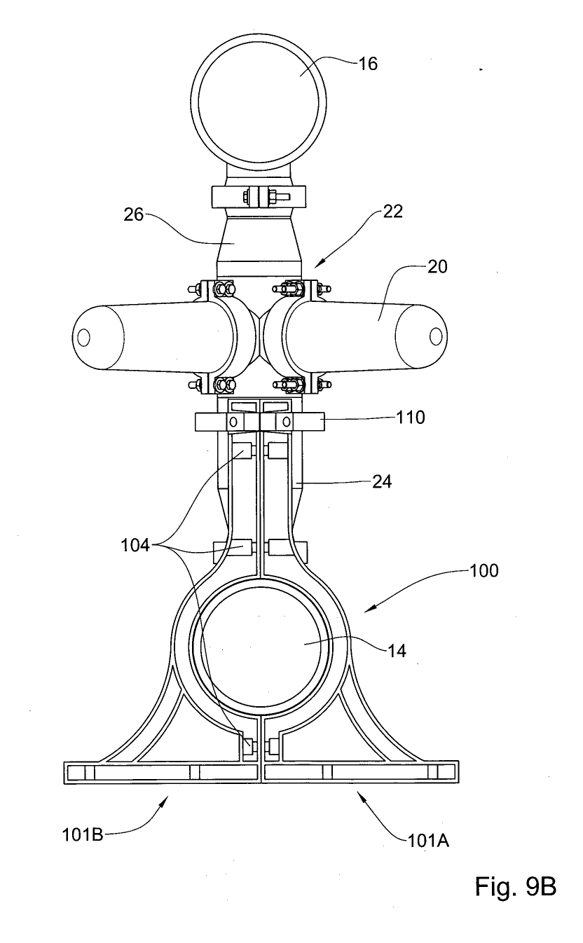

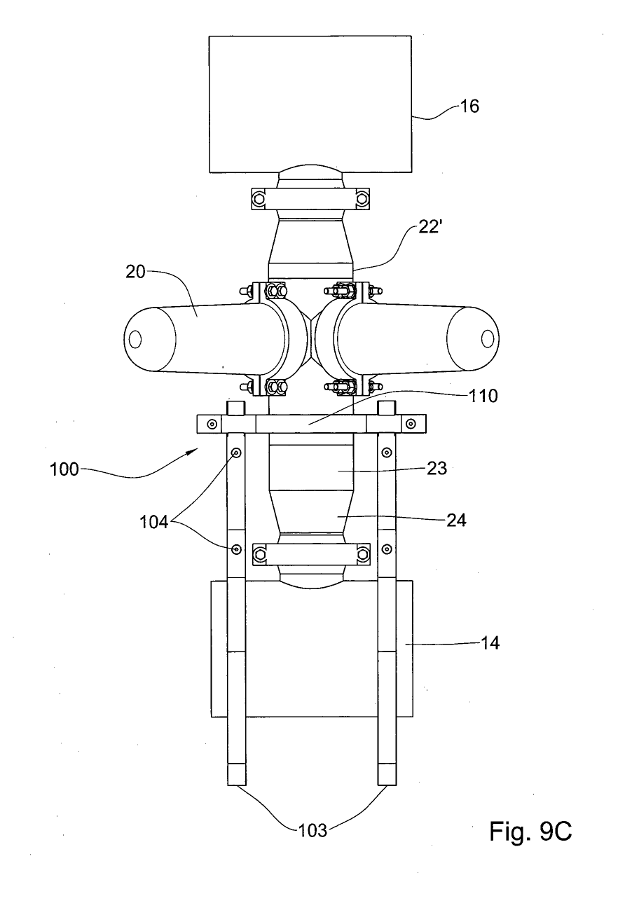

As seen best in FIGS. 9A and 9B, at the assembled position, the main raw fluid supply line 14 is clampingly embraced by the support portion 106 and the interconnecting inlet pipe 24 is clampingly embraced by bracing member 110. It is seen that the bracing member 110 is fitted below the filtering assembly 12 and therefore, the length of the respective interconnecting inlet pipe 24 is longer than in a neighbouring filtration flow path. This arrangement offers on the one hand easy access to the filtering assembly 12, and on the other hand provides adequate support for the system.

However, it is appreciated that the length of the interconnecting inlet pipe 24 may be such that a support member can be associated with each filtration flow path, or with alternating ones, as illustrated in the drawings.

In FIG. 9C there is illustrated a modification of the example illustrated in FIGS. 9A and 9B, wherein the support system 100 is the same as that illustrated in the previous figures, however with bracing member 110 now embracing a pipe extension 23 integrally extending below the manifold 22′ (rather than embracing inlet pipe 24 as in the previous example).

1. A filtration array comprising a main raw fluid supply line and a main filtered fluid collecting line, at least one filtration flow path extending between said main raw fluid supply line and main filtered fluid collecting line, each at least one filtration flow path configured with a filtering assembly comprising a three or more filter units extending from a manifold configured on said filtration flow path and being in flow communication with the main raw fluid supply line and the main filtered fluid collecting line.

2. A filtration array according to claim 1, wherein a longitudinal axis of the manifold extends coaxial with the filtration flow path.

3. A filtration array according to claim 1, wherein a longitudinal axis of the manifold extends in a plane defined by the main raw fluid supply line and the main filtered fluid collecting line and intersecting the longitudinal axis of the raw fluid supply line and of the main filtered fluid collecting line.

4. A filtration array according to claim 1, wherein the main raw fluid supply line and the main filtered fluid collecting line extend parallel to one another.

5. A filtration array according to claim 1, wherein the main raw fluid supply line and the main filtered fluid collecting line extend substantially horizontally.

6. A filtration array according to claim 1, wherein the longitudinal axis of the manifold extends substantially vertically.

7. A filtration array according to claim 1, wherein the filtration array comprises two or more filtering assemblies, said filtering assemblies disposed substantially parallel to one another.

8. A filtration array according to claim 1, wherein the filter units of each filtering assembly extend substantially coplanar, with a longitudinal axis of each filter unit extending in a plane intersecting a plane defined by the main raw fluid supply line and said main filtered fluid collecting line.

9. A filtration array according to claim 1, wherein the longitudinal axis of the filter units intersect the longitudinal axis of a respective filtration flow path.

10. A filtration array according to claim 1, wherein the longitudinal axis of the filter units extend substantially horizontally.

11. A filtration array according to claim 1, wherein the longitudinal axes of the filtration flow paths of the filtration array are substantially parallel to one another.

12. A filtration array according to claim 1, wherein the longitudinal axes of the manifolds of the filtration array are substantially parallel to one another.

13. A filtration array according to claim 1, wherein the filter units of one filtering assembly are disposed such that their longitudinal axis intersects a longitudinal axis of the filter units of a neighboring filtering assembly, however in different plains.

14. A filtration array according to claim 1, wherein the filter units of neighboring filtering assemblies are disposed at staggered planes such that longitudinal axes of filter units of one filtering assembly extend above/below the longitudinal axes of filter units of the neighboring filtering assembly.

15. A filtration array according to claim 1, wherein the distance between two neighboring filtering assemblies is less than the axial length of a filter unit.

16. A filtration array according to claim 1, wherein the filtration flow path is configured with at least one coupling to a drain line, extending between the main raw fluid supply line abd the manifold of said filtration flow path.

17. A filtration array according to claim 1, wherein the filtration flow is configured with at least one faucet extending below the manifold of said filtration flow path.

18. A filtration array according to claim 1, wherein a manifold for fluid coupling a plurality of filter units to a filtration flow path extending between a main raw fluid supply line and a main filtered fluid collecting line.

19. A filtering assembly for mounting between a main raw fluid supply line and a main filtered fluid collecting line, said filtering assembly comprising three or more filter units, each of which extending from a manifold configured for being in flow communication with the main raw fluid supply line and the main filtered fluid collecting line.

20. A filtration assembly according to claim 19, wherein the manifold comprises a housing with a main inlet port coupleable to the main raw fluid supply line and extending to an inlet chamber, and a main outlet port coupleable to the main filtered fluid collecting line; a plurality of filter unit couplers extending from the housing, each configured for coupling thereto a filter unit; a distribution port associated with each filter unit coupler and extending from said inlet chamber and configured for coupling to an inlet port of a respective filter unit; and a collecting port associated with each filter unit coupler and extending form an outlet chamber and configured for coupling to an outlet port of a respective filter unit.

21. A manifold for fluid coupling a plurality of filter units to a filtration flow path extending between a main raw fluid supply line and a main filtered fluid collecting line, said manifold comprising a housing with a main inlet port coupleable to the main raw fluid supply line and extending to an inlet chamber, and a main outlet port coupleable to the main filtered fluid collecting line; a plurality of filter unit couplers extending from the housing, each configured for coupling thereto a filter unit; a distribution port associated with each filter unit coupler and extending from said inlet chamber and configured for coupling to an inlet port of a respective filter unit; and a collecting port associated with each filter unit coupler and extending form an outlet chamber and configured for coupling to an outlet port of a respective filter unit.

22. A manifold according to claim 21, for use in a filtration array according to claim 1 or 20.

23. A manifold according to claim 21, wherein the distribution port and collecting port of the filter unit couplers extend substantially coaxially.

24. A manifold according to claim 21, wherein the filter unit couplers are disposed symmetrically about a longitudinal axis of the manifold.

25. A manifold according to claim 21, wherein the manifold is configured for use in a filtration array comprising a main raw fluid supply line and a main filtered fluid collecting line, at least one filtering assembly extending between said main raw fluid supply line and said main filtered fluid collecting line; each of said at least one filtering assembly comprising three or more filter units; each of said filter units extending from the manifold being in flow communication with the main raw fluid supply line and the main filtered fluid collecting line.

26. A manifold according to claim 21, wherein a longitudinal axis of the filter unit couplers extends substantially normal to the longitudinal axis of the manifold.

27. A manifold according to claim 21, wherein the filter unit couplers are screw-type or bayonet-type couplers.

28. A manifold according to claim 21, wherein the manifold is made as a unitary injection molded article.

29. A manifold according to claim 21, wherein the main inlet port and the main outlet port are configured for direct or indirect coupling to the main raw fluid supply line and the main filtered fluid collecting line, respectively.

30. A manifold according to claim 21, wherein the filter unit couplers are disposed symmetrically about a longitudinal axis of the manifold.

31. A support system for supporting a filtration array, said support system comprises a pair of ground supports each configured with at least a main line support portion for supporting one of a main raw fluid supply line and a main filtered fluid collecting line; a filtration assembly arresting portion for coupling to a filtration assembly extending between the main raw fluid supply line and the main filtered fluid collecting line, and a bracing arrangement for interconnecting two neighboring supports.

32. A support system according to claim 31, wherein the support is configured with a main line support portion for supporting a bottom one of the main raw fluid supply line and the main filtered fluid collecting line.

33. A support system according to claim 31, wherein the ground supports are each composed of two symmetric members disposed in a mirror-like fashion and fastened to one another.

34. A support system according to claim 31, wherein the ground supports and/or bracing arrangement are made of injection molded material.

35. A support system according to claim 31, wherein the bracing arrangement is composed of two symmetric members disposed in a mirror-like fashion and fastened to one another.

36. A support system according to claim 31, wherein the bracing arrangement serves also as the filtration assembly arresting portion.

37. A support system according to claim 31, wherein the bracing arrangement arrests one of a pipe section extending from a bottom one of the main raw fluid supply line and the main filtered fluid collecting line to the manifold, and a lower extension pipe portion of the manifold.

38. A support system according to claim 31, wherein a longitudinal axis of the bracing arrangement extends substantially perpendicular to the at least main line support portion.

39. A support system according to claim 31, wherein the longitudinal axis of the bracing arrangement extends substantially normal to the support portion of the ground support.

40. A support system according to claim 31, for supporting a filtration array according to claim 1.
